(19) United States
(12) Patent Application Publication
(10) Pub. No.: US 2005/0095187 A1
(43) Pub. Date: May 5, 2005

(54) Insert liner for chamber entrance

(76) Inventors: Huan-Liang Tzeng, Hsinchu City (TW); Ping-Jen Cheng, Jhongli City (TW); Jung-Hsiang Chang, Hsinchu City (TW)

Correspondence Address: DUANE MORRIS, LLP;IP DEPARTMENT, ONE LIBERTY PLACE, PHILADELPHIA, PA, 19103-7396, US

(21) Appl. No.: 10/701,668

(22) Filed: Nov. 5, 2003

(51) Int. Cl. B01J 19/00

(52) U.S. Cl. 422/241

(57) ABSTRACT

An insert liner for a passage has a hollow liner shielding the passage from accumulation of particles during a manufacturing operation, the insert liner resiliently expands inside the passage to secure the insert liner in the passage without fasteners, and the liner has a nonporous surface that accumulates the particles.

### FIELD OF THE INVENTION

The present invention relates to improvement of a preventive maintenance operation that requires equipment shut down to remove particle deposition on a chamber wall.

### BACKGROUND

A known manufacturing equipment for fabricating a spin-on dielectric has a polymer deposition chamber. In the chamber, a polymer is deposited on a thin semiconductor wafer while the wafer spins edgewise to uniformly distribute the polymer as an interlayer dielectric on the wafer surface. The chamber has a narrow slit-like passage or passageway. A robot blade transports the wafer along the slit-like passage to project the wafer at least partially in the deposition chamber. During the spin-on dielectric operation, some of the polymer is scattered and deposits or accumulates against the passage interior wall. There, particles of polymer tend to build-up or accumulate, which would require preventative maintenance to remove the deposited or accumulated particles.

Preventive maintenance would be required to remove a build-up of polymer particles from the slit-like passage. Inspection of the narrow slit-like passage for cleanliness of the build-up of particles is difficult. Removing the polymer particles from the narrow slit-like passage is time consuming, and requires equipment shut down during a preventive maintenance.

An improved preventative maintenance would simplify the removal of particles from the slit-like passage. Cleaning the particles from the slit-like passage would be performed quickly to shorten the equipment shut-down time.

### SUMMARY OF THE INVENTION

The invention improves preventative maintenance by simplifying the removal of particles from a passage, for example, a slit-like passage for a robot blade at the end of a robot arm transporting a semiconductor wafer to a polymer deposition chamber. The invention is a hollow shield that shields the passage from deposition of particles that accumulate during a manufacturing operation, for example, a manufacturing operation for depositing a polymer layer on a semiconductor wafer.

The invention includes an insert liner that has a nonporous surface, and the surface is also impermeable to the flow of air. The insert liner is inserted into a passage to line the passage and shield the passage interior wall from particles that would tend to deposit or accumulate on the passage interior wall. The particles accumulate on the nonporous surface of the insert liner instead of on the passage interior wall.

The insert liner secures to the interior wall without fasteners, and is easily installed. Further the insert liner is easily removed together with the deposited or accumulated particles on the liner. Removing the insert liner removes the particles that have accumulated on the nonporous surface of the insert liner, which eliminates inspection of the passage for cleanliness. The shut-down time for preventive maintenance is substantially reduced by quickly removing the insert liner as compared with the shut-down time required to clean the particles from the passage interior wall, and inspecting the passage interior wall for cleanliness.

According to an embodiment of the invention, the insert liner is inserted into the passage and quickly secures in the passage without fasteners. The insert liner clips to the interior wall, which secures the insert liner in the passage.

According to an embodiment of the present invention, the insert liner has a hollow slotted sleeve. One end of the slotted sleeve has a narrow slit-like entrance. The slotted sleeve widens to a wide end. The wide end of the sleeve collapses resiliently to a smaller circumference to enter the passage during insertion of the insert liner along the passage. The wide end resiliently expands inside the passage. When the insert liner is fully inserted, the wide end of the slotted sleeve resiliently biases frictionally against the surrounding passage interior wall to form a barrier seal between the insert liner and the surrounding passage. The barrier seal eliminates spacing between the insert liner and the surrounding passage. The barrier seal repels particles that would attempt to force their way between the insert liner and the surrounding passage. The resilient bias against the surrounding passage interior wall frictionally secures the insert liner within the passage in a clip-like manner. The insert liner is easily and quickly removed to remove the deposited or accumulated particles.

An embodiment of the invention will now be described by way of example, with reference to the accompanying drawings.

### DESCRIPTION OF THE DRAWINGS

FIG. 1 is a side view of a portion of a known polymer deposition chamber having a slit-like passage for a robot blade at the end of a robot arm transporting a semiconductor wafer to project the wafer at least partially into the chamber while a polymer is deposited on the wafer.

FIG. 2 is a perspective view of a chamber liner for lining a polymer deposition chamber.

FIG. 3 is a perspective view of an insert liner for installation in the slit-like passage of a polymer deposition chamber.

FIG. 4 is another perspective view of the insert liner.

FIG. 5 is a diagrammatic view disclosing the chamber and the passage in section, and further disclosing the insert liner in section and being resiliently deformed for entry in the passage.

FIG. 6 is a view similar to FIG. 5, and further disclosing installation of the insert liner in the passage.

FIG. 7 is a diagrammatic view of a clearance space between blade screws and the passage interior wall.

### DETAILED DESCRIPTION

FIG. 5 discloses a portion of a known manufacturing equipment (100) having a deposition chamber (102) and a narrow slit-like passage (104) or passageway (104) opening into the chamber (102). For example, the chamber (102) comprises a polymer deposition chamber (102) of a known polymer deposition equipment (100).

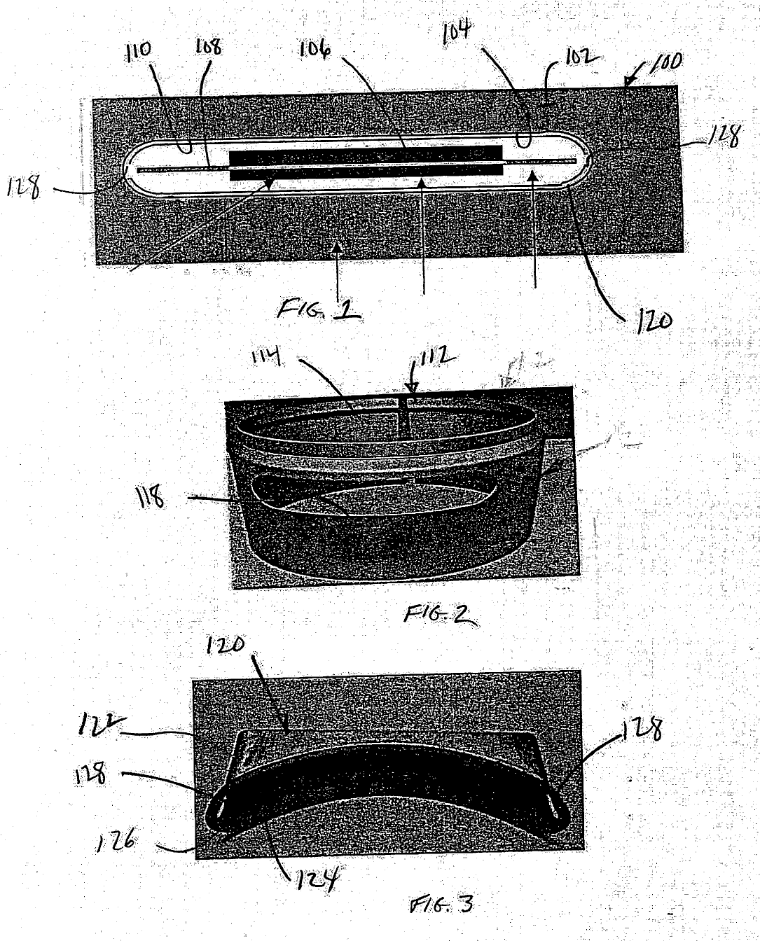

FIG. 1 discloses, that during a manufacturing operation a robot blade (106) at the end of a robot arm transports a suitable workpiece (108) along the slit-like passage (104) to project the workpiece (108) at least partially in the chamber (102) of the manufacturing equipment (100). For example, the robot blade (106) transports a semiconductor wafer (108) along the slit-like passage (104) to project the wafer (108) at least partially in the deposition chamber (102). During a wafer coating operation, a fluid polymer is deposited on a thin semiconductor wafer (108) while the robot blade (106) holds the wafer (108) as the wafer (108) spins edgewise to uniformly distribute the polymer as an interlayer dielectric on the wafer surface. Some of the polymer is scattered and deposits or accumulates against the passage interior wall (110). The particles of polymer tend to build-up or accumulate, which would require preventative maintenance to remove the deposited or accumulated particles.

FIG. 2 discloses a thin chamber liner (112) that conforms to the shape of the deposition chamber (102), for example, a polymer deposition chamber of a known polymer deposition equipment (100). A deposition chamber (102) means any manufacturing equipment chamber, including an etching chamber or a deposition chamber, for example, in which particles will result from performance of a manufacturing operation in the chamber (102), and in which particles become deposited in the slit like passage (104 disclosed by FIG. 1. The chamber liner (112) has a barrel shaped side wall (114) that conforms to a barrel shaped side wall (116) of the manufacturing equipment chamber (102). The side wall (114) has an entrance opening (118) to fit over the slit like passage (104) disclosed by FIG. 1.

FIG. 3 discloses an insert liner (120) for the passage (104) disclosed by FIG. 1. The insert liner (120) is inserted into the passage (104) to line the passage (104) and shield the passage interior wall (110) from particles that would tend to deposit or accumulate on the passage interior wall (110). The particles accumulate on a nonporous surface of the insert liner (120) instead of on the passage interior wall (110).

The invention improves preventative maintenance by simplifying the removal of particles from a slit-like passage (104), for example, a slit-like passage (104) for a robot arm transporting a semiconductor wafer (108) to a polymer deposition chamber (102). The invention shields the passage (104) from deposition of particles that accumulate during a manufacturing operation, for example, a manufacturing operation for depositing a polymer layer on a semiconductor wafer (108).

According to an embodiment of the invention, the insert liner (120) is inserted into the passage (104) and quickly secures in the passage (104) without fasteners. The insert liner (120) clips to the passage interior wall (110), which secures the insert liner (120) in the passage (104).

According to an embodiment of the present invention, the insert liner (120) has a hollow slotted sleeve (122). One open end (124) of the slotted sleeve (122) has a narrow slit-like entrance that is encircled by a wide lip flange (126). The lip flange (126) and the entrance of the sleeve (122) are curved to conform to the curved interior of the barrel shaped chamber side wall(1 12). When the side wall (112) of the chamber (102) is lined with the chamber liner (112) disclosed by FIG. 2, the sleeve (122) is inserted through the entrance opening (118) through the chamber liner (112). The curved lip flange (126) and the curved open end (124) of the sleeve (122) conform against the curved interior of the chamber liner side wall (114). The lip flange (126) overlaps the entrance opening (118) through the chamber liner (112).

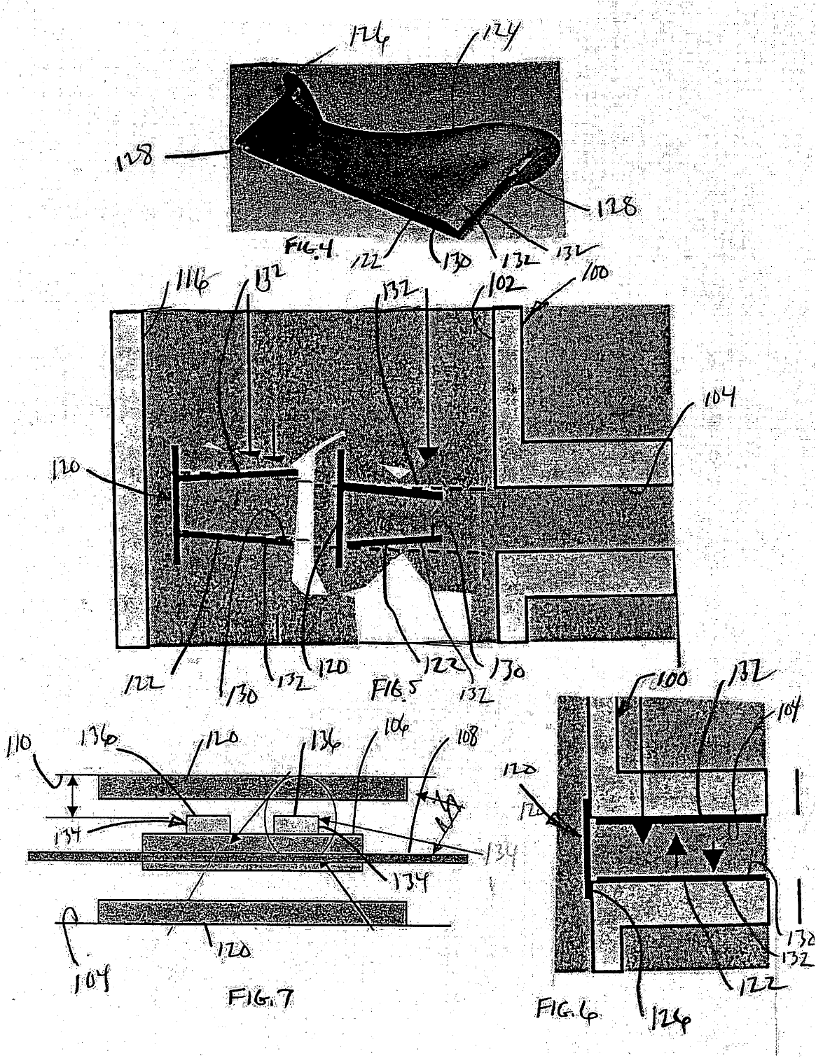

With reference to FIGS. 3 and 4, the sleeve (122) extends from the lip flange (126), and has a narrow slit-like shape. For example, the insert liner (120) is a continuous thin wall molded body of about 0.6 mm, millimeters, thickness. The insert liner has an interior surface that faces away from the side wall (112) of the chamber (102). The surface is nonporous, which accumulates particles and airborne contaminants, and prevents them from permeating the insert liner. The surface is also impermeable to air, which prevents even the smallest particles from penetrating through the insert liner. Inexpensive material, for example, polyethylene or polypropylene is suitable for the insert liner (120). Slots (128) are molded through the sleeve (122) The slots (128) extend from the rear of the lip flange (126) and lengthwise of the sleeve (122) and through a slotted wide end (130) of the sleeve (122). The slots (128) reduce the difficulty in molding a narrow slit-like shape for the sleeve (122). Further, the slots (128) bifurcate the sleeve (122) to form opposing sleeve sections (132). The sleeve (122) is molded with a tapered shape, such that the sleeve (122) widens at the wide end (130). The opposing sleeve sections (132), as made, diverge from the rear of the lip flange (126) to the wide end (130). The wide end (130) of the sleeve (122), as made, is wider than the passage interior wall (110).

FIG. 5 is a diagrammatic view of the sleeve (122) in section to disclose the sleeve sections (132) diverging, as made, such that the slotted sleeve (122) widens from the rear of the lip flange (126) to the wide end (130). FIG. 5 further discloses the chamber (102) in section and the passage (104) in section. At first, the wide end (130) of the sleeve (122) is unable to enter the passage (104). The wide end (130) of the sleeve (122) is resiliently collapsed to a smaller circumference to enter the passage (104). For example, the wide end (130) of the sleeve (122) is resiliently collapsed by resiliently deforming the material of the sleeve (122). The continuous lip flange (126) resists deformation of the sleeve (122) at that end (124). The slots (128) narrow in width when the opposed sleeve sections (132) pivot resiliently toward each other.

FIG. 6 discloses that the sleeve (122) wide end (130) resiliently expands to a larger circumference when the sleeve (122) is inside the passage (104). The slots (128) widen in width as the opposed sleeve sections (132) resiliently pivot away from each other. FIG. 7 discloses the sleeve (122) fully inserted in the passage (104). When the insert liner (120) is filly installed with the sleeve (122) being fully inserted in the passage (104), the wide end (130) of the slotted sleeve (122) resiliently biases against the surrounding passage interior wall (110) creating friction to secure the insert liner (120) within the passage (104) with a clip-like retention. The insert liner (120) is fully inserted when the rear of the lip flange (126) registers against the interior of the chamber (102) or the interior of the chamber liner (112) covering the chamber interior. The insert liner (120) is quickly installed without fasteners, and the clip-like retention holds the insert liner (120) stationary during a manufacturing operation, such as, a polymer coating operation. When the insert liner is fully inserted, the wide end of the slotted sleeve resiliently biases frictionally against the surrounding passage interior wall to form a barrier seal between the insert liner and the surrounding passage. The barrier seal eliminates spacing between the insert liner and the surrounding passage. The barrier seal repels particles that would attempt to force their way between the insert liner and the surrounding passage. The resilient bias against the surrounding passage interior wall frictionally secures the insert liner within the passage in a clip-like manner. The insert liner is easily and quickly removed to remove the deposited or accumulated particles.

During preventative maintenance, the insert liner (120) is easily and quickly removed to remove the deposited or accumulated particles. The removed insert liner (120) is replaced with a duplicate insert liner (120). The insert liner (120) is easily removed together with the deposited or accumulated particles on the liner. Removing the insert liner (120) removes the particles that have accumulated on the insert liner (120), which eliminates inspection of the passage (104) for cleanliness. The shut-down time for preventive maintenance is substantially reduced by quickly removing the insert liner (120) as compared with the shut-down time required to clean the particles from the passage interior wall (110), and inspecting the passage interior wall (110) for cleanliness.

FIG. 7 discloses the robot blade (106) having blade screws (134) with 0.5 mm screw head height. The screw heads (136) would have a clearance gap of 1.5 mm from the passage interior wall (110). However, with the insert liner (120) installed in the passage (104), the 0.6 mm thickness of the insert liner (120) reduces the clearance gap between it and the blade screws (134). Thus, to restore a safe gap, the screw heads (136) are reduced in height to 0.2 mm, for example, by a grinding operation to widen the gap to a safe gap of about 1.2 mm between the blade screws (134) and the insert liner (120).

A preferred embodiment has been disclosed. Other embodiments and modifications are intended to be covered by the spirit and scope of the appended claims.

1. An insert liner for a passage, comprising:
a hollow liner shielding the passage from accumulation of particles during a manufacturing operation, and the liner has a nonporous surface that accumulates the particles.

2. The insert liner of claim 1 and further comprising:
a hollow sleeve secured in the passage without fasteners.

3. The insert liner of claim 1 and further comprising:
a sleeve having a wide end that is resiliently collapsible to a smaller circumference for insertion into the passage.

4. The insert liner of claim 1 and further comprising:
a sleeve that is resiliently expandable in the passage.

5. The insert liner of claim 1 and further comprising:
a hollow sleeve resiliently biased against a surrounding passage interior wall.

6. The insert liner of claim 1 and further comprising:
a slotted sleeve.

7. The insert liner of claim 1 and further comprising:
a slotted sleeve extending from a rear of a lip flange on one end of the slotted sleeve.

8. The insert liner of claim 1 and further comprising:
a sleeve resiliently collapsible to a smaller circumference and resiliently expandable in the passage.

9. The insert liner of claim 1 and further comprising:
a sleeve resiliently collapsible to a smaller circumference and resiliently expandable in the passage; and
a lip flange on one end of the sleeve conforming to an interior of a chamber.

10. The insert liner of claim 1 and further comprising:
a sleeve resiliently collapsible to a smaller circumference and resiliently expandable in the passage;
the sleeve having sleeve sections that are resiliently pivotable toward and away from one another; and
a lip flange on one end of the sleeve conforming to an interior of a chamber.

11. A method of shielding a passage from deposition of particles during a manufacturing operation, comprising the steps of:
inserting an insert liner in the passage; and
shielding the passage with a nonporous surface of the insert liner to accumulate particles on the nonporous surface during a manufacturing operation.

12. The method as recited in claim 11, further comprising the step of:
securing the insert liner in the passage without fasteners.

13. The method as recited in claim 11, further comprising the steps of:
securing the insert liner in the passage without fasteners; and
removing the insert liner together with particles having accumulated on the insert liner.

14. The method as recited in claim 11, further comprising the steps of:
securing the insert liner in the passage without fasteners;
removing the insert liner together with particles having accumulated on the insert liner; and
replacing the insert liner with a duplicate insert liner.

15. The method as recited in claim 11, further comprising the steps of:
resiliently collapsing the insert liner to a smaller circumference; and
resiliently expanding the insert liner inside the passage to secure the insert liner in the passage.

16. The method as recited in claim 11, further comprising the steps of:
resiliently collapsing the insert liner to a smaller circumference;
resiliently expanding the insert liner inside the passage to secure the insert liner in the passage without fasteners; and
removing the insert liner from the passage together with particles accumulated on the insert liner during a manufacturing operation.

17. A method of using an insert liner, comprising:
assembling a hollow insert liner in a passage of a deposition chamber;
depositing a material on a workpiece that is transported along the passage to the chamber;
collecting particles of the material on a nonporous surface of the insert liner while the insert liner prevents accumulation of particles of the material on an interior of the passage.

18. The method of claim 17, further comprising:
removing the insert liner from the passage together with accumulated particles of the material; and
replacing the insert liner with a duplicate insert liner.

19. The method of claim 17, further comprising:
securing the insert liner in the passage without fasteners.

20. The method as recited in claim 17, further comprising:
securing the insert liner in the passage without fasteners; and
removing the insert liner together with accumulated particles of the material.

21. The method as recited in claim 17, further comprising the steps of:
resiliently collapsing the insert liner to a smaller circumference; and
resiliently expanding the insert liner inside the passage to secure the insert liner in the passage.

22. The method as recited in claim 17, further comprising the steps of:
resiliently collapsing the insert liner to a smaller circumference;
resiliently expanding the insert liner inside the passage to secure the insert liner in the passage without fasteners; and
removing the insert liner from the passage together with accumulated particles of the material.
